(19) United States
(12) Patent Application Publication
(10) Pub. No.: US 2010/0171760 A1
(43) Pub. Date: Jul. 8, 2010

(54) METHOD AND APPARATUS FOR PRESENTING OVERLAY IMAGES

(75) Inventor: Yuval Itkin, Zoran (IL)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: DSP Group Ltd., Herzelia (IL)

(21) Appl. No.: 12/349,380

(22) Filed: Jan. 6, 2009

(51) Int. Cl. G09G 5/00

(52) U.S. Cl. 345/634

(57) ABSTRACT

A method and system for displaying overlay images on top of base images on a digitally-controlled display device. If the overlay image comprises an area at which only the values of the base image are to be displayed, the area or part thereof is indicated, and pixels of the overlay image within the area are not fetched from an image source and are not mixed with the corresponding values of the pixels of the base area. Thus, multiple fetch and mixing operations are saved, which provide better resource utilization of the system, and bandwidth and processing saving.

### TECHNICAL FIELD

The present disclosure relates to image processing in general, and to a method and system for displaying overlay images, in particular.

### BACKGROUND

Most computerized devices and platforms that present graphics often have to display a base image, and on top of the base image, another image wherein only parts of the base image are hidden or mixed with the overlay image. Examples include overlay images whose task is to add information to the base image, such as the desktop of a windows-based computer, which displays a background image, on top of which an overlay image comprising icons and a transparent area is displayed, or a mobile device displaying a background image and an overlay image comprising a multiplicity of indicators surrounding a transparent area in which the relevant part of the base image is displayed. Further examples include applications, such as presenting a base image and an overlay image which provides a decorative frame that hides the boundary areas of the base image.

An overlay image is blended with the base image using the alpha-blending method, which enables the appearance of partial transparency of the overlay image. In the alpha-blending method, each pixel of the overlay image is associated with a transparency factor, which enables the relevant area of the overlay image to appear partially or fully transparent. Thus, if an area of the overlay image is to be completely transparent, each pixel of the area is multiplied by a transparency factor which equals zero, and the zero result is added to the value of the corresponding pixel of the base image, thus leaving the pixel of the base image intact.

Thus, it is often the case that an overlay image contains relatively small meaningful areas which should hide or be blended with the base image, and relatively large areas in which only the relevant parts of the base image are displayed. However, even for such overlay images, the overlay image is still determined or fetched in full from a storage device, followed by mixing or otherwise integrating the overlay image in its entirety with the base image. The resulting process wastes resources such as bandwidth for fetching the image, and processing power for mixing the two images wherein the mixing leaves a significant part of the base image unchanged.

There is thus a need in the art for a method and system for efficient handling of overlay images, and in particular overlay images containing significant areas which are intended to be transparent so that only the base image is displayed.

### SUMMARY OF THE INVENTION

A method and apparatus for handling overlay images to be displayed on top of base images, wherein the overlay images comprise a hole, i.e. a transparent area in which only the corresponding contents of the base image are to be displayed.

In accordance with one aspect of the disclosure, there is thus provided a method for displaying on a digitally-controlled display device a combined image determined from a base image and an overlay image, such that a first part of the combined image is identical to a corresponding part of the base image, the method comprising: receiving characteristics of a second part contained within the first part; determining that one or more first pixels are within the second part; for each of the first pixels, fetching a first value of a corresponding pixel in the base image, and determining that the value of a pixel in the combined image corresponding to the first pixel is identical to the first value; determining that one or more second pixels are external to the second part; and for each second pixel, fetching a second value of a corresponding pixel in the base image and a third value of a corresponding pixel in the overlay image, and determining that the value of a pixel in the combined image corresponding to the second pixel is combined from the second value and the third value. Within the method, the value of a pixel in the combined image corresponding to the second pixel is optionally combined from the second value, the third value and one or more parameters. Within the method, the second part is optionally a rectangular area. Within the method, the second part is optionally a rectangular area bounded within the first area. The method can further comprise a step of determining the characteristics of the first part. Within the method, the second part optionally comprises one or more third pixels for which the value of a corresponding pixel in the combined image is a mixture of a value of a pixel corresponding to the third pixel in the overlay image and a value of a pixel corresponding to the third pixel in the base image. The method can further comprise the steps of: determining one or more third pixels within the second part; and for each of the third pixels, fetching a fourth value of a pixel in the base image corresponding to the third pixel, and a fifth value of a pixel in the overlay image corresponding to the third pixel, and determining that the value of a pixel in the combined image corresponding to the third pixel is combined from the fourth value and the fifth value. Within the method the value of a pixel in the combined image corresponding to the third pixel is optionally combined from the fourth value, the fifth value and one or more parameters.

Another aspect of the disclosure relates to a system for displaying on a digitally-controlled display device a combined image combined from a base image and an overlay image, such that a first part of the combined image is identical to a part corresponding to the first part within the base image, the system comprising: one or more sources for providing pixel values of the base image and of the overlay image; a mixing component for mixing a value of one or more pixels of the base image received from a source, with a value of a corresponding pixel of the overlay image received from the a source, into a value of a corresponding pixel of the combined image; and a display controller for transferring the pixel values of the combined image to the digitally-controlled display device, wherein the mixing component uses the value of a first pixel contained within the first part of the base image as a value for a pixel within the combined image corresponding to the first pixel, and wherein the mixing component combines the value of a second pixel external to the first part of the base image, with the value of pixel of the overlay image corresponding to the second pixel, for a pixel within the combined image corresponding to the second pixel. The system can further comprise a memory device for storing the combined image. Within the system, the mixing component further determines the first pixel belonging to the first part, and the second pixel external to the first part.

### BRIEF DESCRIPTION OF THE DRAWINGS

The present invention will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure.

In the drawings:

FIG. 1 is an exemplary illustration of a base image, an overlay image, and a combination thereof, in accordance with the disclosure;

FIG. 2 is a flowchart of the main steps in an embodiment of a method for displaying overlay images; and

FIGS. 3A and 3B are two exemplary systems in which the disclosed method is used.

### DETAILED DESCRIPTION OF PREFERRED EMBODIMENTS

The disclosure relates to a method and apparatus for efficient storage, fetching and processing of overlay images to be displayed on a digitally-controlled display device.

In accordance with the disclosure, overlay images which contain an area to be ignored, i.e., a transparent area through which the base image is seen, are stored and manipulated so that the area to be ignored or part thereof is indicated. Thus, pixels contained in the area to be ignored can be omitted from the stored image, the pixels are not fetched from storage into memory, and are not manipulated or mixed with the base image, thus saving storage, fetching time, and bandwidth and processing power, and enabling other processing to take place more efficiently.

Thus, while ordinary display controllers read the full content of the overlay image and the base image in order to create the mixed image, most of the original image is not overlaid and thus resources are wasted. The disclosed method and apparatus take advantage of the ratio between the full size of the overlay image and the size of the area of interest, and save these resources.

The area to be ignored, which is the area of the combined image which is identical to the corresponding area of the base image, hereinafter the “hole” in the overlay image, can be defined using any coordinate or size sequence. In many situations it is most efficient to describe the “hole” as a rectangle bounded in the area to be ignored, and more particularly, the largest rectangle that is still bounded in the area to be ignored. In other situations, another geometric shape, or a collection of two or more rectangles or other geometric shapes can be used.

The base image and the overlay image are preferably of the same dimensions, so each pixel in one image has a corresponding pixel in the other image, as well as in the combined image. However, there may be pixels existing in only one of the base image or the overlay image. The values of such pixels in the combined image are determined according to the image at which they exist, if the pixels are required to exist in the combined image. The term “corresponding pixels” in two images refers to pixels having the same location or coordinates within their respective images, or to pixels that refer to the same location on the display device.

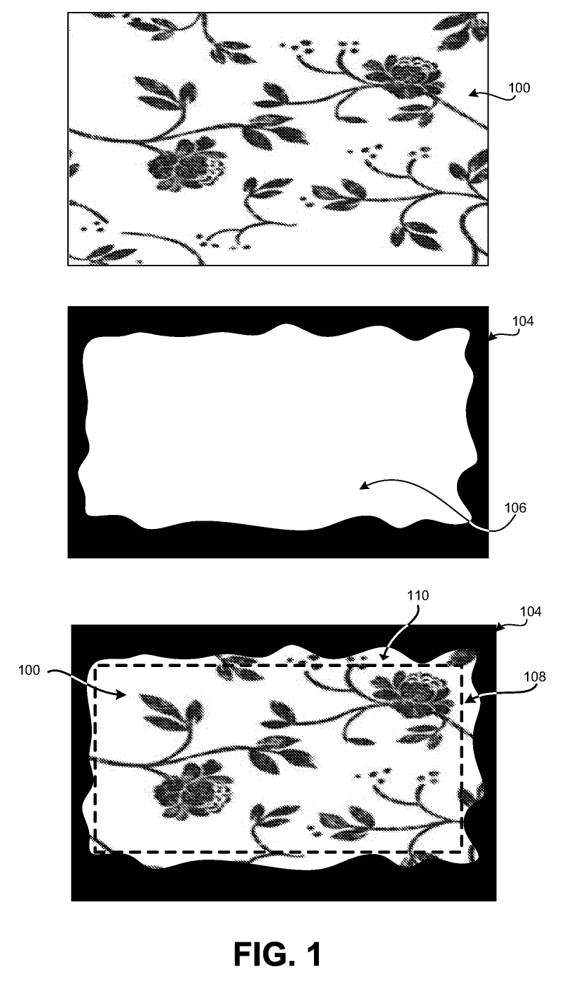

Referring now to FIG. 1, illustrating the concept of the disclosed method and system. Image 100 is the base image to be displayed, and overlay image 104 is a frame to be displayed on top of image 100 so that the boundary areas of image 100 are hidden, but pixels within area 106 are identical to the corresponding pixels of base image 104. Area 108 is the largest bounding rectangle that fits within the “hole”, i.e. the area of the overlay image to be ignored while processing. The coordinates of rectangle 108 relatively to overlay image 104 are stored in association with overlay image 104. The pixels of overlay image 104 which are within area 108 are optionally not stored, and are not fetched when the overlay image is to be displayed. The controller that generates the combined image does not perform any alpha-blending or other processing on the pixels of overlay image 104 within area 108, so that the corresponding pixels are identical to the corresponding pixels of base image 100. Area 110 comprises pixels which are not defined to be in hole area 108, although the values of the pixels of the combined image corresponding to pixels of area 110 are identical to the value values of the corresponding pixels of the base image. These pixels will be treated as in existing methods and system, therefore they should be as few as possible, and hole area 108 should be as large as possible, as long as it is contained within area 106.

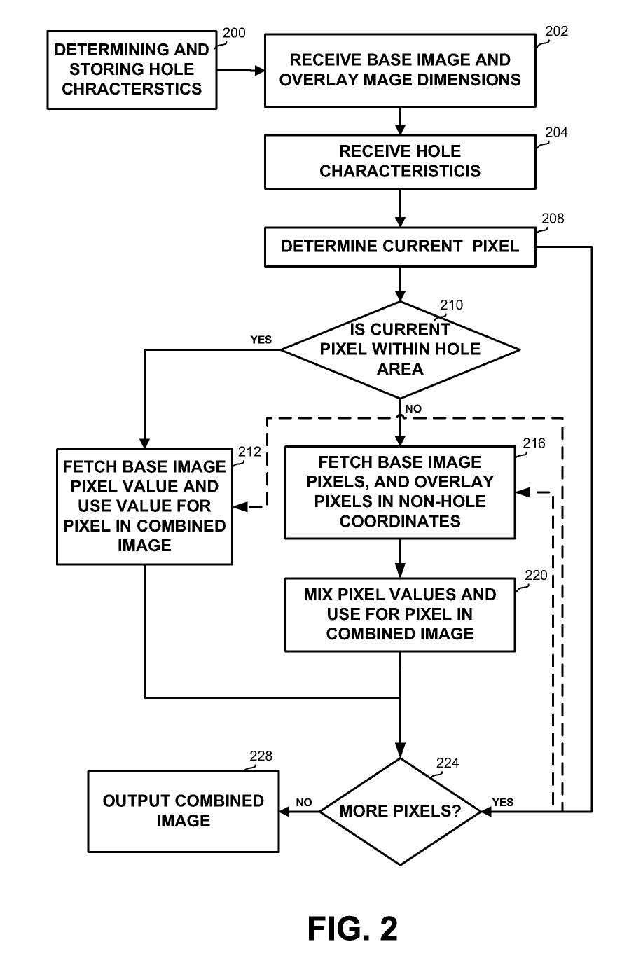

Referring now to FIG. 2, showing a flowchart of the main steps in a method for efficient handling of overlay images.

On step 200, the characteristics of a hole area for which the pixel values of the combined image are to be identical to the pixel values of the base image are determined and stored in association with the base image or the overlay image. The hole area may be defined partial to a larger area, such as a rectangular area which is contained within an area of a more complex shape. The larger the hole area is defined, as long as it is contained within the area to be ignored, the larger is the efficiency of the method and system.

On step 202, the dimensions of the base image and the overlay image are received. Optionally, the offset between the images, if any, is received as well. Otherwise the images are assumed to be positioned relatively to each other so that their top left corners coincide.

On step 204, characteristics of the area to be ignored within the overlay image are received. The characteristics optionally describe an hole area which is contained within a larger area to be ignored, such as rectangular area 108 which is contained within area 106. Area 108, also referred to as a hole area can be described using any coordinate or size sequence that define one or more closed shapes. In preferred embodiments, the coordinates are the top left corner and the bottom right corner of a rectangle, or the top left corner, width and height of a rectangle, wherein the rectangle is the hole. The top left corner and the bottom right corner, if supplied, are preferably provided relatively to the overlay image.

On step 208 a current pixel to begin generating the combination image with is determined. It is common although not mandatory to begin with the top left corner of the image, being the pixel at coordinate (0,0).

On step 210 it is determined whether the pixel is within the hole area or not. If it is, then on step 212 only the pixel value of the base image are fetched from the memory, and used for the corresponding pixel in the combined image.

If the pixel is not within the hole area, then on step 216 the values of the corresponding pixels in the base image and in the overlay image are fetched from the source. Then on step 220 the corresponding pixel of the combined image is generated by mixing the corresponding pixels of the base image and the overlay image. Optionally, mixing also takes into account one or more parameters such as a transparency value associated with the pixels of the base image or the overlay image.

If on step 224, if it is determined that no more pixels in the image are to be handled, the combined image is output on step 228. Otherwise, the process repeats for the pixel determined on step 208. In some embodiments, it is determined on step 210 whether the pixel is in the hole area or not. In other embodiments, if more efficient determination of the next pixel is performed, steps 208 and 210 can be omitted, and the flow continues directly to step 216 or to step 212.

In one preferred embodiment, assuming that the hole area is rectangular, the determination whether a pixel is in the hole area or not may be performed as follows: If the current pixel is in the hole area, it is then determined how many consecutive pixels within the same row also belong to the hole area (or what is the coordinate of the last pixel within the row which is still comprised in the hole area). The values of any one or more of the corresponding pixels within the base image are fetched, depending on the memory at which the image is stored and the communication channel such as the bus.

If the current pixel is not in the hole area, it is determined how many consecutive pixels within the same row are also not in the hole area. For any one or more of these pixels, the pixel values of the base image as well as the pixel values of the overlay image are fetched on step 216 and mixed on step 220. The process then repeats for the following lines. Alternatively, when determining that pixels within a handled line are contained in the hole area, the number of consecutive pixels within the row which are contained in the hole area is stored. It is then determined in how many lines the hole area is comprised, and when processing the same number of the following lines, the stored number of pixels is used. If no pixel of the handled line is contained within the hole area, it is determined how many consecutive lines also have no such pixels, and for these lines all data is fetched from the base image and from the overlay image and mixed as efficiently as possible.

It will be appreciated that for pixels which do not belong to the hole area but for which the value of the combined image should be identical to the values of the base image, such as pixels in area 110 of FIG. 1, the mixing will be performed, although the result will be identical to the pixels of the base image. Therefore, area 110 should be as small as possible which is achieved by making hole area 108 as large as possible.

Pixel values can be fetched one pixel at a time, in full or partial rows, or the like, depending on the used memory and on the bus or other communication channel connecting the memory and the mixing component. It will be appreciated that additional algorithms can be designed to increase efficiency by determining which pixels are to be fetched from the base image and at what order, and which pixels are to be fetched from the base image and the overlay image, and at what order. Thus, it will be appreciated that step 210 of determining whether a pixel belongs to the hole area, step 212 of fetching pixel values from the base image, step 216 of fetching pixel values from the base image and the overlay image, and step 220 of mixing pixel values can be performed and interrelated in a multiplicity of ways and orders, and that the displayed flowchart is exemplary only. Preferably, the steps are performed such that the determination of step 210 whether a current pixel is in the hole area or not, is not performed for all pixels in the base image but for significantly less pixels. However, when an overlay image has a hole, the combined image is characterized in having at least one pixel within the hole area, so that its value is identical to the corresponding pixel of the base image, and at least one pixel is external to the hole area so that its value is a mixture of the values of the corresponding pixels in the base image and in the overlay image.

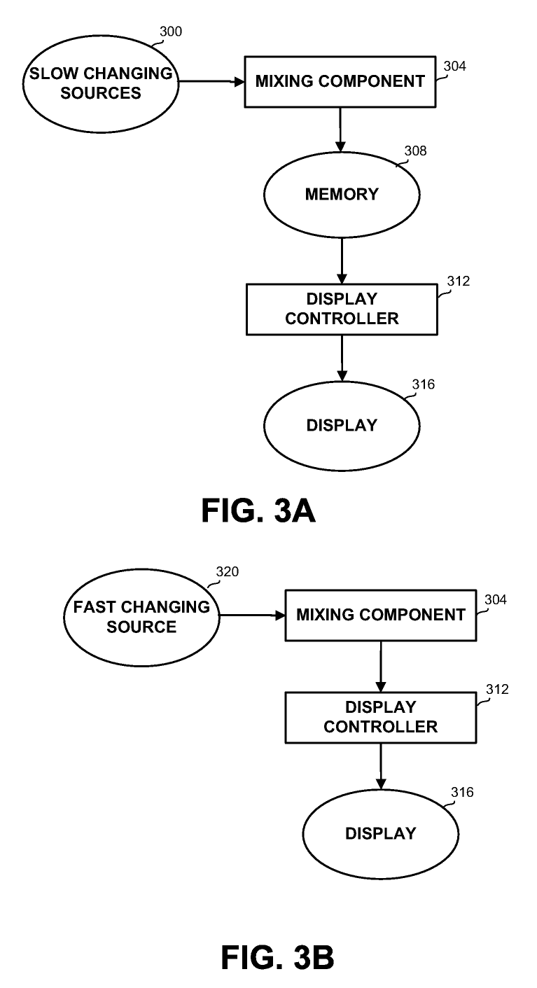

Referring now to FIGS. 3A and 3B, showing two preferred embodiments of a system in which the disclosed method is used.

FIG. 3A relates to an environment with a slow-changing image source, such as a mobile phone, in which mixing operations are performed at lower frequency relatively to other applications as detailed in association with FIG. 3B below in which a gaming or a video application alike may update the image source at rates such as 50 Hz. Image sources 300 provide the pixel values for the base image as well as the overlay image, in applications wherein none of the images changes at high rate. The image data is received from sources 300, and mixed by mixing component 304. Mixing component 304 uses the disclosed method, and thus avoids accessing image sources 300 for pixels of the overlay image which are in the hole area, and avoids mixing these pixels. The pixels that should be mixed, for example the boundary area shown in FIG. 1 above is mixed in any required method, such as alpha-blending. In slow-changing applications, the resulting combined image is optionally stored in a memory device 308 from which it may be fetched again. The combined image is then transferred to display controller 312, and then to a digitally-controlled display device 316, such as a CRT display, LCD display or the like.

FIG. 3B relates to applications involving fast changing sources, such as video applications. Fast changing image sources 320 provide images at a higher rate than sources 300 of FIG. 3A, for example at a rate of about 20 Hz to about 100 Hz. The image data is accessed by mixing component 304 substantially as described in association with FIG. 3A above, but is preferably not stored, due to the fast changing rate. The combined image, comprising mixed parts as well as parts identical to the base image is transferred to display controller 312 and to display device 316.

Mixing component 304 uses the method discussed in association with FIG. 2 above for fetching the images and for mixing them.

It will be appreciated that the disclosed method and system are particularly useful for fast-changing sources of graphic information, such as video applications, for example video games. In such applications, if the video stream is in 50 Hz rate, saving a significant portion of the alpha-blending which takes place 50 times a second saves significant processing resources.

The method is preferably performed by hardware components. The additional hardware required for mixing component 304 relatively to prior art components is used for handling the definition of the hole, and for coordinate or size comparison logic, for identifying the hole area, determining whether a pixel is in the hole area or how many pixels or rows are in the hole area, and skipping accesses to the pixels within the overlay image which are within the hole area.

As an example for resource saving, consider an image having dimensions of 206 pixels×140 pixels, wherein the hole size is 180 pixels×96 pixels.

The bandwidth required for the combined image is the product of the mixing rate and the total data of the combined image.

combined_image_badwidth=fetching_and_mixing_rate×data_per_image=fetching_and_mixing_rate×(base_image_size+overlay_image_size)=fetching_and_mixing_rate×(2*base_image_size−hole_size)=fetching_and_mixing_rate×(2×206×140−180×96)=0.7×mixing_rate

Thus, for such dimensions, approximately 30% of the fetching and mixing is saved, since the operations are designed to be performed efficiently and involve mainly compare operations which do not require heavy processing.

It will be appreciated by a person skilled in the art that the method and apparatus can be used also in situations of a “hole within a hole”. Such situations refer to an overlay image having a transparent area, within which there is one or more relatively small areas which are non-transparent, i.e. their pixels should be mixed with the corresponding pixels of the base image. Such situation can occur, for example, in a desktop of a windows-based computer, which displays a background image on top of which an overlay image comprising icons on the peripheral areas of the base image, but one or more icons are to be displayed over a more central area of the base image. Such “hole within a hole” situation can be manipulated in a variety of ways, such as handling the overall image as detailed in association with FIG. 2 above and then handling specifically the small non-transparent areas. Alternatively, such situation can be handled by processing the small areas as an integral part of handling the overall combination.

The disclosed method and apparatus provide for ignoring an area of an overlay image, which leaves the corresponding area of the base image unchanged. The method and system reduce the number of memory accesses by avoiding memory access operations required for fetching ignored pixels, as well as avoiding futile processing for mixing such values. The disclosed method and system thus provide significant decrease in fetching time and processing time and power of overlay images. The decrease becomes more significant for overlay images in which the hole is relatively large. The effect of using the method and system increases in applications in which the image source changes in relatively high rate, due to the many fetching and mixing operations avoided for each update.

In addition to the system power consumption improvement achieved by the method and system, additional system improvement is obtained as more cycles are available for other system resources, such as CPU access to the memory, thus yielding higher system performance as well.

It will be appreciated that the system and apparatus are not limited to one hole in an overlay image, but rather multiple holes can be defined and taken into account, by avoiding memory accesses and processing of pixels comprised in any of the holes.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step of component to the teachings without departing from the essential scope thereof. Therefore, it is intended that the disclosed subject matter not be limited to the particular embodiment disclosed as the best mode contemplated for carrying out this invention, but only by the claims that follow.

1. A method for displaying on a digitally-controlled display device a combined image comprised from a base image and an overlay image, such that a first part of the combined image is identical to a corresponding part of the base image, the method comprising:
receiving characteristics of a second part contained within the first part;
determining that at least one first pixel is within the second part;
for the at least one first pixel, fetching a first value of a corresponding pixel in the base image, and determining that the value of a pixel in the combined image corresponding to the first pixel is identical to the first value;
determining that at least one second pixel is external to the second part; and
for the at least one second pixel, fetching a second value of a corresponding pixel in the base image and a third value of a corresponding pixel in the overlay image, and determining that the value of a pixel in the combined image corresponding to the second pixel is combined from the second value and the third value.

2. The method of claim 1 wherein the value of a pixel in the combined image corresponding to the second pixel is combined from the second value, the third value and at least one parameter.

3. The method of claim 1 wherein the second part is a rectangular area.

4. The method of claim 1 wherein the second part is a maximal rectangular area bounded within the first area.

5. The method of claim 1 further comprising a step of determining the characteristics of the first part.

6. The method of claim 1 wherein the second part comprises at least one third pixel for which the value of a corresponding pixel in the combined image is a mixture of a value of a pixel corresponding to the third pixel in the overlay image and a value of a pixel corresponding to the third pixel in the base image.

7. The method of claim 1 further comprising the steps of:
determining at least one third pixel within the second part; and
for the at least one third pixel, fetching a fourth value of a corresponding pixel in the base image and a fifth value of a corresponding pixel in the overlay image, and determining that the value of a corresponding pixel in the combined image is combined from the fourth value and the fifth value.

8. The method of claim 7 wherein the value of a pixel in the combined image corresponding to the third pixel is combined from the fourth value, the fifth value and at least one parameter.

9. A system for displaying on a digitally-controlled display device a combined image comprised from a base image and an overlay image, such that a first part of the combined image is identical to a part corresponding to the first part within the base image, the system comprising:
at least one source for providing pixel values of the base image and of the overlay image;
a mixing component for mixing a value of at least one pixel of the base image received from the at least one source, with a value of a corresponding pixel of the overlay image received from the at least one source, into a value of a corresponding pixel of the combined image; and
a display controller for transferring the pixel values of the combined image to the digitally-controlled display device,
wherein the mixing component uses the value of a first pixel contained within the first part of the base image as a value for a pixel within the combined image corresponding to the first pixel, and wherein the mixing component combines the value of a second pixel external to the first part of the base image, with the value of pixel of the overlay image corresponding to the second pixel, for a pixel within the combined image corresponding to the second pixel.

10. The system of claim 9 further comprising a memory device for storing the combined image.

11. The system of claim 9 wherein the mixing component further determines the first pixel belonging to the first part, and the second pixel not belonging to the first part.
